(19) United States
(12) Patent Application Publication
(10) Pub. No.: US 2009/0320944 A1
(43) Pub. Date: Dec. 31, 2009

(54) FIR anion automobile and ship tank

(76) Inventor: Yixin Guo, Ronkonkoma, NY (US)

Correspondence Address: Yixin Guo, 256 Holbrook Ave, Ronkonkoma, NY, 11779, US

(21) Appl. No.: 12/215,629

(22) Filed: Jun. 28, 2008

(51) Int. Cl. F03B 11/02

(52) U.S. Cl. 137/561 R

(57) ABSTRACT

This is a FIR (Far Infrared Ray) anion tank for automobile and ship, and its raw materials are plastic and material that generate FIR anion under normal temperature, such as tourmaline, germanium ore powder, and other ore powders that generate FIR and anion under normal temperature. Automobile and Ship Tanks are tanks of automobiles, motorcycles and ships that consume gasoline or diesel oil as fuel. This kind of fuel tank has the advantages of saving fuel consumption and reducing the emission of exhaust. On the other hand, it is feasible to manufacture FIR and anion plastic, rubber or metal patch, sticking them on the outer or inner shell of the gasoline tank; it is also feasible to paste anticorrosive FIR anion coating on the on the outer or inner shell of the tank.

### BACKGROUND OF THE INVENTION

This invention involves plastic fuel tanks used in internal combustion engine vehicles, such as used in automobiles and ships' gasoline or diesel engine, in particular it involves a kind of plastic fuel tank with far infrared and anion composite structure for automobiles and ships. While this plastic fuel tank can save fuel, it can also reduce the emission of exhaust such as carbon dioxide.

### SUMMARY OF THE INVENTION

Currently, there are two normal types of fuel savers in the market, the outer circle model and the joint model. The outer circle model usually consists of two hemispherical economizing units. When use, join the two units outside of the caliber of the transmitting pipeline of the automobile and ships; it acts upon the running fuel inside of the pipeline by enveloping the outer caliber of the transmitting pipeline. This type of fuel saver usually uses the theory of high-polarity magnetic field and far infrared anion activation theory, realizing the purpose of fuel-saving. Joint fuel saver is usually designed to have a fuel-saving channel to be joined with the transmitting pipeline when use, and when the fuel runs through this section of the pipeline, the fuel will be activated according to the theory of the high-polarity magnetic field and the far infrared activation theory, realizing the purpose of fuel saving.

However, the common limitation of the two models of fuel saver includes: 1. only when the fuel runs through the saver, the high-polarity magnetic field and the far infrared anion could activate the fuel, but for fuel that has not run through the saver there is no such effect; 2. because of the reasons stated above, the period of time that the saver acts upon the fuel is too short, limiting the activation efficiency, affecting the fuel-saving effect, especially for the outer circle model, as a result of the segregating effect of the transmitting pipeline, the effect of the high-polarity magnetic field and far infrared anion is significantly reduced; 3, for both of the outer circle model and the joint model fuel savers, there is technical problems with the installation, for instance, for the joint model it is necessary to sever the transmitting pipeline to install the device. For this matter, it is important to devise a more effective fuel saver to realize the purpose of saving fuel and reducing pollution, based on the current theories of fuel-saving.

The reason that plastic fuel tank can be extensively used in auto industry is due to its several advantages compared to metal fuel tanks. For example, it is easy to be designed in any shapes; it bears good economic benefits with high production efficiency and low manufactory costs; it is light with good impact resistance and intensity capacity; it will not cause exploration during combusting; it has little fuel leakage and high durable capacity.

Because fuel tank is one of the structural and functional components, as well as an important safety component of the automobile, the material of the tank requires the following characters: cold and heat resistance, stress cracking resistance, weather aging resistance, solvent resistance and chemical resistance, impact resistance, leakage resistance, flame resistance, explosion proof, etc. Presently there are two categories of plastic fuel tank: one is the single layer structural fuel tank blew molding by Polyethylene containing 500,000 to 800,000 moleculae with its several surface treatment applied on tank's interior surface to improve its resistance against fuel leaking. The other one is single/multiple layers structural fuel tank blew molding by High Molecular Weight High Density Polyethylene and other materials for conglutination and resistance purpose.

But the present plastic fuel tanks, besides the characters as stated in the above paragraph, do not bearing the same fuel-saving and pollution-reducing effect. Therefore, how to design a plastic fuel tank bearing such effect is the issue of this invention.

The invention provides a kind of simple-structured plastic fuel tank that is effective for fuel saving and is beneficial for environmental protection. For the said purposes, the technique employed by this invention is: a far infrared anion plastic fuel tank for automobiles and ships, and it consists of tank container body, on which there are far infrared and anion carrier structures that are made from tourmaline or tourmaline and germanium ore powder materials. The structure of the carrier will be chosen from one of the following:

The far infrared anion fuel tank for automobiles and ships, which raw materials are plastic and the materials that generate far infrared and anion under normal temperature, such as tourmaline, germanium ore powder.

The powder or nano-powder of far infrared and anion material can be inlayed in the interior of the container body wall.

The far infrared anion fuel tank, wherein the block made from far infrared and anion material can be buried in the interior of the container body wall.

The far infrared anion fuel tank, wherein the paste made from far infrared and anion meterials can be pasted to the interior or exterior of the container.

The far infrared anion fuel tank, wherein the liner made from far infrared and anion material can be set on the interior of the container body wall.

The far infrared anion fuel tank, wherein the shell made from of far infrared and anion materials can be set on the exterior of the container body wall.

### BRIEF DESCRIPTION OF SEVERAL VIEWS OF THE DRAWINGS

FIG. 1 is a three-dimensional view of plastic fuel tanks for automobiles and ships;

FIG. 2 is a sectional view of plastic fuel tanks with far infrared and anion powder.

FIG. 3 is a sectional view of plastic fuel tank with pre-buried patch or block carriers;

FIG. 4 is a sectional view of plastic fuel tank with an interior layer of paste carrier;

FIG. 5 is a sectional view of plastic fuel tank with an exterior layer of paste carrier;

FIG. 6 is a sectional view of plastic fuel tank with interior liner carriers;

FIG. 7 is a sectional view of plastic fuel tank with exterior shell carriers.

In the above Figures: 1. container body; 2. fuel inlet; 3. fuel outlet; 4. powder carrier; 5. block carrier; 6. interior paste carrier; 7. exterior paste carrier; 8. interior liner carrier; 9. exterior shell carrier.

### DETAILED DESCRIPTION OF THE INVENTION

The terms and contents in the said invention are explained as follows:
1. In the said invention, the said “plastic fuel tank for automobiles and ships” indicates plastic fuel tanks in the internal combustion engines used in automobiles and ships which consume gasoline or diesel oil.
2. In the said invention, the said “Tourmaline” can generate FIR and anion, of which FIR is more effective. The said “germanium ore powder” mainly generates anions. Other materials that can generate anions include: China Gui gem, China Shenzhou stone, China Guiyang stone and Tourmaline. These anion materials can be used either separately or with two or more kinds combined.
3. In the said invention, when plastic fuel tanks adopt the inlayed powder or nano-powder structure with FIR and anions effects, the technology employed in this convention is: The FIR Anion Fuel-Saving and Pollution-Reducing Plastic Tank which consists of the following materials (with respective weight percent)

| | |
|---|---|
| Polyethylene | 85%~95%; |
| FIR Anion Material | 5%~15%; |

Among which, the FIR anion material is composed by Tourmaline or Guiyang Stone.

The related description of the above-described design is explained as follows: 1 In the said invention, to improve the fuel-saving and pollution-reducing effect, such FIR anion material also includes Germanite which consists 10%-20% of the weight of such FIR anion.

In the said invention, Tourmaline is a crystal natural mineral. It is mainly found in America, Brazil and China. It consists of several microelements, i.e. Fe, Mn, Mg, Li etc. Its color varies from different chemical constituents as black, pink, green, purple, etc. Its chemical formula is Na (Mg, Fe, Mn, Li, Al)₃Al₆ [Si₆O₁₈] (B O₃)₃ (OH, F)₄. Tourmaline has its piezoelectric effect and thermoelectric effect. It can emit the FIR with wavelength of 4-14 microns, which is usually called the light of life. It can also emit the vitamin of air-anions. The Tourmaline found in Xinjiang province of Chinacan emit the FIR with the emissivity of 88% and 4260 anions per cm³.

In the said invention, the China Guiyang Stone is another environment-protecting produce. It is a crystal mineral in either white or red. It bears a strong emission of FIR and can emit the most anions comparing with other minerals with 7000-12000 anions per cm³. It contains the following chemical constituents:

| | | | | | |
|---|---|---|---|---|---|
| SiO₂: | 66-77% | Al₂O₃: | 12-19% | Fe₂O₃: | 0.1-0.7% |
| TiO₂: | 0.02-0.03% | CaO: | 0.18-0.4% | MgO: | 0.06-0.11% |
| K₂O: | 4-6.5% | Na₂O₃: | 3.5-6.5% | Others: | over 8.5-13% |

The Guiyang stone has been tested, its products are all processed from high quality raw materials, such products is of 5-10 times in efficiency comparing with other products. The diameter of the granule is from 200 nanometer to 75 nanometer.

In the said invention, the Germanite is a natural raw germanite mineral material. Such Germanite can emit FIR and anions. And its emitted anion is strong than FIR. Other materials that can generate anions include: Gui gems, Shenzhou stones and Qibing stones. These anion materials can be used either separately or with two or more kinds combined.

In the said invention, in order to improve specific performance of plastic fuel tank, certain activators and materials may be added into the mixed materials of fuel tank. Such activators include anti-static materials such as polyesteramide (PEEA); combustion-proof material such as aluminum hydroxide; barrier materials such as nylon (PA) or Ethylene-Vinyl Alcohol Copolymer (EVOH). The percents of such activators and materials please refer to relevant plastic products processing requirements.
4. In the said invention, when plastic fuel tanks adopt the pre-buried patch or block structure, finished patches or blocks with FIR and anion effects could be pre-buried in the plastic fuel tank walls while making plastic fuel tanks; for example, when producing plastic plastic fuel tanks, carrier patches or blocks could be pre-buried in the plastic fuel tank walls.
5. In the said invention, when plastic fuel tanks adopt the sticker structure, stickers with FIR and anion effects could be first prepared, and then stuck to the interior or exterior of the plastic fuel tank walls. The stickers could either cover small area or large area, or even the whole area. This structure suits both metal and non-metal plastic fuel tanks.
6. In the said invention, when plastic fuel tanks adopt the paste structure, a layer of paste carrier with FIR and anion effect could be applied to the interior or exterior surfaces of finished plastic fuel tank walls.
7. In the said invention, when plastic fuel tanks adopt the interior liner or the exterior shell structure, interior liners with FIR and anion effect could be set inside of the plastic fuel tank wall, or exterior shells with FIR and anion effect could be set outside of the plastic fuel tank wall.

The theory of this invention is: each fuel is a hydrocarbon with different molecular weight. They are usually molecules with alkyl branch consists of carbon atoms and hydrogen atoms by valence bonds. Such covalent bonds between carbon atoms and hydrogen atoms bring polarities to molecules. The Dipole between molecular will produce static gravitation which further produces big molecular clusters. Such force is called the Van Waals Force. Such big molecular cluster will affect the complete combustion of fuel. The fuel molecules are assembling together under Van Waals Force which results an incomplete combustion. This invention adopts FIR anion fuel-saving and pollution-reducing fuel tanks. It makes the fuel tanks of autos and ships possess both fuel storing and fuel saving functions. In other word, the fuel tank is a large fuel saver as well. Such fuel tank can apply FIR and anions directly on fuel while storing it. Van Waals Force between fuel molecules was broken under the function of FIR and anions, and those molecules will form long-chains arrangement in order, then they will become short-chains from long-chains, even single molecules, which results the average distance between molecules increased. And then the percent of fuel will decrease and its fluidity will increase, especially the spray ability will significantly increase. Such results may allow the fuel more completely mix with the air and therefore result a complete combustion. It will also reduce the harmful gases being exhausted and improve the combustion efficiency of the fuel, wherefore meet the fuel-saving and pollution-reducing purpose.

Because of the application of the said technique, this invention of FIR anion plastic fuel tank for automobiles and ships has the following merits comparing with the current technology:
1. This invention of FIR anion plastic fuel tank for automobiles and ships itself is a grand fuel saver, and its fuel-saving function is greater than normal fuel saver, therefore the effect of fuel-saving and detrimental exhaust-reducing is significant.
2. This invention of FIR anion gasoline tank for automobiles and ships emanates FIR and anions which could have direct and long-term interactions with the fuel, atomizing the fuel molecule complexes, catalyzing oil molecules in the fuel, increasing the efficiency of FIR and anion in the activation of the fuel, benefiting the sufficiency of combustion and enhance the efficiency of combustion.
3. In this invention, FIR and anions have direct interactions with the fuel, and the disturbance caused by the movement of the automobiles and ships facilitates the smooth and sufficient interaction between FIR, anion and the fuel, and therefore further enhance the effect of fuel-saving.
4. This invention of FIR anion plastic fuel tank for automobiles and ships has flexible fuel-activating carrier with strong pertinence, especially that the immersion technique it adopts makes its interaction with the fuel long and sufficient, initiating new paths to install fuel savers, providing good foundation for further fuel-saving effect.

Now the utility model invention is further described with drawings and actualized examples:

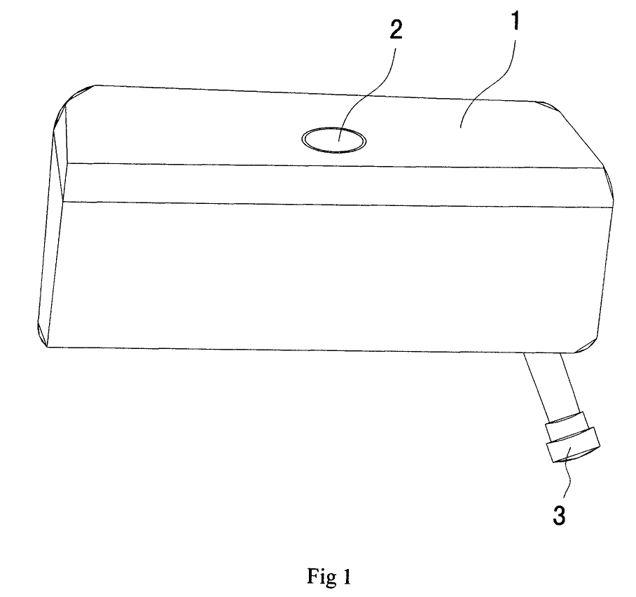

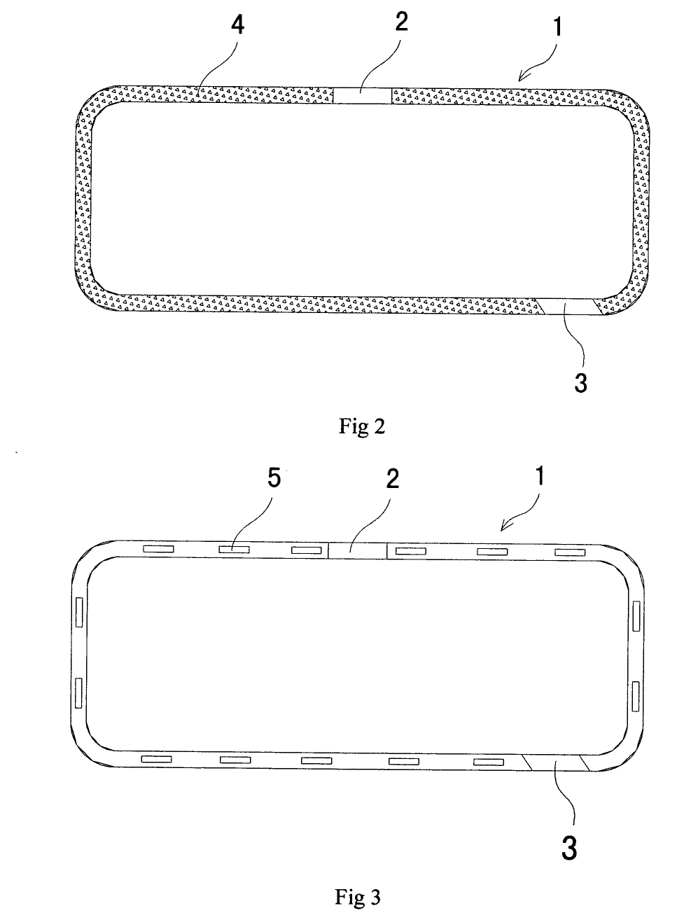

Example 1: as described indicated in FIG. 1 and FIG. 2, this FIR anion plastic fuel tank for automobile and ship consists of container body 1; on its top there is fuel inlet 2, and on its bottom there is fuel outlet 3. In the interior wall of the container body 1 there is FIR and anion granule carrier 4, as described in FIG. 2; this granule carrier 4 consists of Tourmaline or Tourmaline and germanium ore powder. Tourmaline can generate FIR and anion, of which FIR is more effective; germanium ore powder mainly generates anions. Other materials that can generate anions include: Gui gems, Shenzhou stones and Tourmaline. These anion materials can be used either separately or with two or more kinds combined. When producing plastic fuel tanks, granule carrier 4 with FIR and anion effects could be mixed with normal plastic fuel tank materials and 5-10% granules will be enough. In this way, in the finished plastic fuel tank wall there is naturally granule structure. The said normal plastic fuel tank material could be plastic and so forth.

Example 2: as described indicated in FIG. 3, this FIR anion plastic fuel tank for automobile and ship consists of container body 1; on its top there is fuel inlet 2, and on its bottom there is fuel outlet 3. In the interior wall of the container body 1 there is FIR and anion patch/block carrier 5, as described in FIG. 3; this patch/block carrier 5 consists of Tourmaline or Tourmaline and germanium ore powder. When producing plastic fuel tanks, finished patches or blocks with FIR and anion effects could be pre-buried in the plastic fuel tank walls while producing plastic fuel tanks; for example, when producing plastic plastic fuel tanks, carrier patches or blocks could be pre-buried in the plastic fuel tank walls.

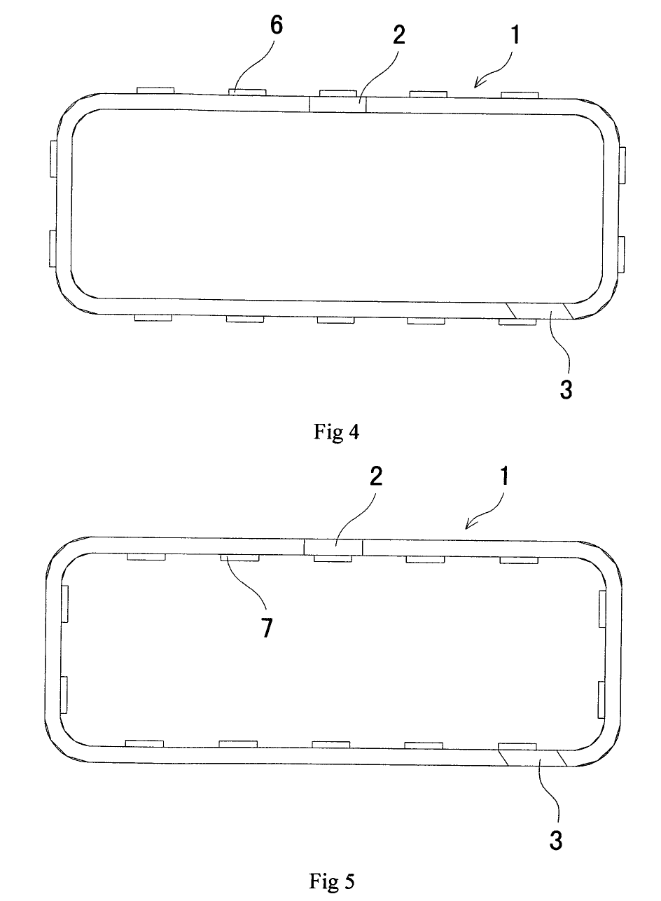

Example 3: as described indicated in FIG. 4, this FIR anion plastic fuel tank for automobile and ship consists of container body 1; on its top there is fuel inlet 2, and on its bottom there is fuel outlet 3. On the exterior wall of the container body 1 there is FIR and anion sticker carrier 6; this sticker carrier 6 consists of Tourmaline and germanium ore powder. When producing plastic fuel tanks, stickers with FIR and anion effects could be first prepared, and then stuck to the interior or exterior of the plastic fuel tank walls. The stickers could either cover small area or large area, or even the whole area. This structure suits both metal and non-metal plastic fuel tanks. FIG. 5 indicates on the interior wall of the container body 1 there is FIR and anion sticker carrier 7; this sticker carrier 7 consists of Tourmaline and germanium ore powder.

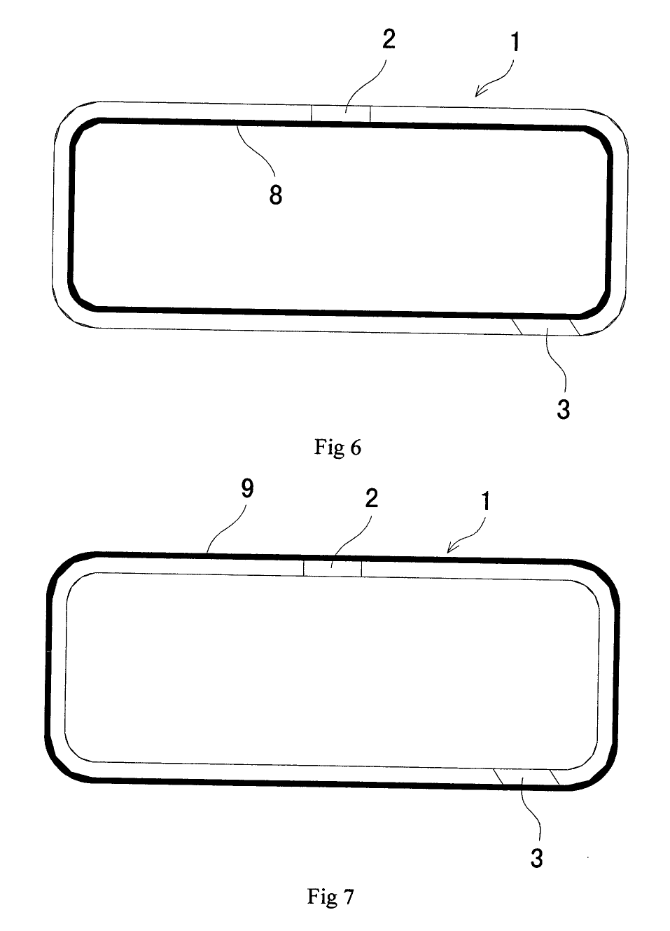

Example 4: as described indicated in FIG. 6, this FIR anion plastic fuel tank for automobile and ship consists of container body 1; on its top there is fuel inlet 2, and on its bottom there is fuel outlet 3. On the interior wall of the container body there is a layer of FIR and anion paste carrier 8, which consists of Tourmaline or Tourmaline and germanium ore powder. When producing plastic fuel tanks, a layer of paste carrier could be pasted on the interior of the walls of finished plastic fuel tanks. FIG. 7 indicates on the exterior wall of the container body there is a layer of FIR and anion paste carrier 9, which, like the interior paste carrier 8, consists of Tourmaline or Tourmaline and germanium ore powder too.

Example 5: as described indicated in FIG. 8, this FIR anion plastic fuel tank for automobile and ship consists of container body 1; on its top there is fuel inlet 2, and on its bottom there is fuel outlet 3. Inside the container body 1 there is an interior liner 10; this interior liner consists of Tourmaline or Tourmaline and germanium ore powder. FIG. 9 indicates outside the container body 1 there is an exterior shell 11, which, like the interior liner 10, consists of Tourmaline or Tourmaline and germanium ore powder.

Example 6: a FIR Anion Fuel-Saving and Pollution-Reducing Plastic Fuel Tank consists of the following materials (with respective weight percent):

| | Material | Material | Material |
|---|---|---|---|
| | Percent 1 | Percent 2 | Percent 3 |
| Linear Low-Density | 85% | 90% | 95% |
| Polyethylene (LLDPE) | | | |
| Tourmaline | 15% | 10% | 5% |

The brand of Linear Low-Density Polyethylene (LLDPE) is Korea SK RG500U. It has good tenacity, low temperature resistance and environment stress resistance.

Manufacturing process 1: smash the Linear Low-Density Polyethylene ( LLDPE) plastic granules by high-speed grinding machine, mix the Tourmaline powders with LLDPE powders with above stated percents as the base material for plastic fuel tank. Technology Process: producing granules by plastic particles and color masterbatch—grinding (particle size is 30-50)—adding the Tourmaline powders with certain percent—measuring powders—filling with Plastic Rolling Molds—heating and molding—cooling down and molding—Inspecting—Trim—Inspecting—Packing and storing.

Manufacturing process 2: smash the Linear Low-Density Polyethylene (LLDPE) plastic granules by high-speed grinding machine, mix the Tourmaline powders (with particle size of 100) with LLDPE powders with above stated percents and heat the mixed powders to get base granule material for plastic fuel tank, and then produce single layer plastic fuel tank with such mixed granules by plastic hollow molding technique.

To improve the fuel leaking resistance, three surface treatments may be applied on to its interior surface after the above stated molding. The first one is Epoxy Spraying method. The second is Sulphonation (SO3 gas). And the last one is Fluorine (F₂) Processing method. Under such method, the nitrogen gas containing 1% of Fluorine will be injected into the fuel tank during its plastic molding processing, which forms the Fluorine layer preventing the fuel leaking. Fluorine Processing applies during the normal plastic processing period, and it will cause chemical changes (including Polarity, Cohesive Energy, Density, and Surface Tension, etc.) of containers' interior surface by replacing the hydrogen atoms in polymer bonds with fluorine bond. Since such changes are on the surface only (with a depth of 50˜100 A), tensile strength and impact strength will not change substantially. After such Fluorine processing, fuel tank's fuel leaking will be prominently reduced.

On Sep. 20, 2007, China Jiefang CA4143P11K2A80 towing vehicle 320 L fuel tank was produced by adopting manufacturing process 2 in this Application Sample. It is tested by China Ministry of Transportation Energy Utilization Supervising and Testing Center under GB/T 14951-2007 Automobile Fuel-Saving Technology Standard, the total fuel-saving rate is 2.3%, acceleration rate is 0.96 (i.e. 0.04 faster) and the free acceleration rate of autos reduced 4.88%. The Testing Center concluded that this product met the requirements of the Fuel-Saving Auto Products Application Technology Standards.

Example 7: a FIR Anion Fuel-Saving and Pollution-Reducing Plastic Fuel Tank consists of the following materials (with respective weight percent):

| | Material | Material | Material |
|---|---|---|---|
| | Percent 1 | Percent 2 | Percent 3 |
| Linear Low-Density | 85% | 90% | 95% |
| Polyethylene (LLDPE) | | | |
| Guiyang Stone | 15% | 10% | 5% |

The brand of Linear Low-Density Polyethylene (LLDPE) is Korea SK RG500U. It has good tenacity, low temperature resistance and environment stress resistance.

The manufacturing process of Sample 2 is same with Sample 1 and will not repeat herein.

Example 8: a FIR Anion Fuel-Saving and Pollution-Reducing Plastic Fuel Tank consists of the following materials (with respective weight percent):

| | Material | Material | Material |
|---|---|---|---|
| | Percent 1 | Percent 2 | Percent 3 |
| Linear Low-Density | 85% | 90% | 95% |
| Polyethylene (LLDPE) | | | |
| Tourmaline | 12% | 8% | 4% |
| Germanite | 3% | 2% | 1% |

The brand of Linear Low-Density Polyethylene (LLDPE) is Korea SK RG500U. It has good tenacity, low temperature resistance and environment stress resistance.

The manufacturing process of Sample 3 is same with Sample 1 and will not repeat herein.

Example 9: a FIR Anion Fuel-Saving and Pollution-Reducing Plastic Fuel Tank consists of the following materials (with respective weight percent):

| | Material | Material | Material |
|---|---|---|---|
| | Percent 1 | Percent 2 | Percent 3 |
| Linear Low-Density | 85% | 90% | 95% |
| Polyethylene (LLDPE) | | | |
| Guiyang Stone | 12% | 8% | 4% |
| Germanite | 3% | 2% | 1% |

The brand of Linear Low-Density Polyethylene (LLDPE) is Korea SK RG500U. It has good tenacity, low temperature resistance and environment stress resistance.

Example 10: a FIR Anion Fuel-Saving and Pollution-Reducing Plastic Fuel Tank consists of the following materials (with respective weight percent):

| | Material | | |
|---|---|---|---|
| | Percent 1 | Material Percent 2 | Material Percent 3 |
| Polyethylene with | 85% | 90% | 95% |
| 500,000~800,000 | | | |
| Tourmaline | 15% | 10% | 5% |

Example 11: a FIR Anion Fuel-Saving and Pollution-Reducing Plastic Fuel Tank consists of the following materials (with respective weight percent):

| | Material | | |
|---|---|---|---|
| | Percent 1 | Material Percent 2 | Material Percent 3 |
| Polyethylene with | 85% | 90% | 95% |
| 500,000~800,000 | | | |
| Guiyang Stong | 15% | 10% | 5% |

Example 12: a FIR Anion Fuel-Saving and Pollution-Reducing Plastic Fuel Tank consists of the following materials (with respective weight percent):

| | Material | | |
|---|---|---|---|
| | Percent 1 | Material Percent 2 | Material Percent 3 |
| Polyethylene with | 85% | 90% | 95% |
| 500,000~800,000 | | | |
| Tourmaline | 12% | 8% | 4% |
| Germanite | 3% | 2% | 1% |

Example 13: a FIR Anion Fuel-Saving and Pollution-Reducing Plastic Fuel Tank consists of the following materials (with respective weight percent):

| | Material | | |
|---|---|---|---|
| | Percent 1 | Material Percent 2 | Material Percent 3 |
| Polyethylene with | 85% | 90% | 95% |
| 500,000~800,000 | | | |
| Guiyang Stone | 12% | 8% | 4% |
| Germanite | 3% | 2% | 1% |

In the above eight Application Samples, anti-static materials may also be added, i.e. Polyesteramide (PEEA), combustion-proof material such as aluminum hydroxide; barrier materials such as nylon (PA) or Ethylene-Vinyl Alcohol Copolymer (EVOH). The percents of such activators and materials please refer to relevant plastic products processing requirements.

1. The invention of the FIR Anion Tornado Fuel Saver has following features: it can be installed in the intake hose between internal combustion engine and air filter, or in the air intake pipe of the burner, which consists of FIR anion carrier structure and an axleless turbocharger.

2. The FIR Anion Tornado Fuel Saver as described in claim 1, wherein the axleless turbocharger is made by a non-rotationally guide turbocharger consisting of a hollow-centered cylindrical vessel and vanes on the interior of the cylindrical vessel.

3. The FIR Anion Tornado Fuel Saver as described in claim 1, wherein the FIR anion carriers are made from tourmaline or tourmaline and germanium ore powder materials, in a structure of a layer of paste made up of FIR and anion carriers pasted to the interior of the cylindrical vessel.

4. The FIR Anion Tornado Fuel Saver as described in claim 1, wherein the FIR anion carriers are made from tourmaline or tourmaline and germanium ore powder materials, in a structure of power or nano-powder made up of FIR and anion carriers inlayed inside the fuel saver that is made from plastics.

5. The FIR Anion Tornado Fuel Saver as described in claim 1, wherein the exterior of the said cylindrical vessel it is pasted a layer of aluminum powder or aluminum foil on the out side, so as to stop FIR and anion from coming out of the vessel;

6. The FIR Anion Tornado Fuel Saver as described in claim 1, wherein the outer diameter of the fuel saver has to match with inner diameter of the air intake hose.
